(19) United States
(12) Patent Application Publication
(10) Pub. No.: US 2026/0309275 A1
(43) Pub. Date: Oct. 8, 2026

(54) CRYOGENIC FLUID STORAGE TANK

(71) Applicant: L'Air Liquide, Société Anonyme pour l'Etude et l’Exploitation des Procédés Georges Claude, Paris (FR)

(72) Inventors: Pierrick COHARD, Les Abrets (FR); Pierre-Alexandre BERTRAND, Sassenage (FR); Marius BOUIN, Sassenage (FR)

(21) Appl. No.: 19/485,077

(22) PCT Filed: Mar. 11, 2024
(86) PCT No.: PCT/EP2024/056424

§ 371 Date: Nov. 17, 2025

(30) Foreign Application Priority Data
Jun. 1, 2023 (FR) FR2305484

(51) Int. Cl. F17C 3/04

(52) U.S. Cl. CPC F17C 3/04; F17C 2201/0123; F17C 2203/0391; F17C 2203/0626; F17C 2203/0636; F17C 2260/033

(57) ABSTRACT

A tank for storing cryogenic fluid, having a sealed inner shell defining the storage volume for the cryogenic fluid and a sealed outer shell arranged around the inner shell with a thermally insulated spacing, the inner shell being connected to the outer shell via at least one tubular neck extending in a longitudinal direction, the neck having, in the longitudinal direction, a portion of somewhat thinned thickness.

### CROSS REFERENCE TO RELATED APPLICATIONS

This application is a 371 of International Application No. PCT/EP2024/056424, filed Mar. 11, 2024, which claims priority to French Patent Application No. FR2305484, filed Jun. 1, 2023, the entire contents of which are incorporated herein by reference.

### BACKGROUND

The invention relates to a tank for storing cryogenic fluid.

More particularly, the invention relates to a tank for storing cryogenic fluid, comprising a sealed inner shell defining the storage volume for the cryogenic fluid and a sealed outer shell arranged around the inner shell with a thermally insulated spacing, the inner shell being connected to the outer shell via at least one tubular neck extending in a longitudinal direction.

It is known to provide cryogenic tanks having one or more tubular necks that are made of more or less conductive materials. The inner shell can also be held in the outer shell via a tie rod assembly or via any other arrangement.

Such tanks must cope with mechanical strength constraints, while limiting thermal inputs.

### SUMMARY

One aim of the present invention is to overcome all or some of the abovementioned drawbacks of the prior art.

For this purpose, the tank according to the invention, furthermore corresponding to the general definition given in the preamble above, is essentially characterized in that the neck comprises, in the longitudinal direction, a portion of somewhat thinned thickness.

Moreover, embodiments of the invention can comprise one or more of the following features:
the inside diameter of the neck is constant, the portion of somewhat thinned thickness in the longitudinal direction being formed by a variation in the outside diameter of the neck,
the portion of somewhat thinned thickness is formed by a progressive reduction in the thickness of the neck in the longitudinal direction,
the progressive reduction in the thickness of the neck in the longitudinal direction is between 0.5 and 2 mm of thinning for a progression of 100 mm in the longitudinal direction,
the neck has a thickness of between 0.5 and 5 mm and preferably of between 1 and 3 mm, the thinned portion having a thickness reduced by 5% to 70% compared with the non-thinned thickness,
the neck is of the fixed type, the two longitudinal ends of the neck being rigidly connected to fixed points situated on the inner shell and on the outer shell respectively, the portion of somewhat thinned thickness being situated between the two longitudinal ends of the neck, for example in the middle part of the neck,
the neck is of the mobile type and has a first longitudinal end rigidly connected to a fixed point, for example the outer shell, and a second longitudinal end connected to a point having freedom of movement, for example the inner shell, the portion of somewhat thinned thickness being situated at the second longitudinal end,
the tank comprises two necks situated at two respective ends of the tank,
the inner shell and/or the outer shell is made of at least one of the following: carbon steel, stainless steel, aluminium and titanium, the neck is made of at least one of the following: carbon steel, stainless steel, aluminium and titanium.

The invention may also relate to any alternative device or method comprising any combination of the features above or below that is within the scope of the claims.

Other particular features and advantages will become apparent upon reading the following description, which is provided with reference to the figures.

### BRIEF DESCRIPTION OF THE FIGURES

The invention will be better understood by reading the following description which is provided purely by way of example, with reference to the appended drawings, in which:

FIG. 1 is a schematic view in longitudinal section of one example of a tank according to one exemplary embodiment of the invention,

FIG. 2 is a schematic sectional view of a first example of a tubular neck according to the invention,

FIG. 3 is a schematic sectional view of a second example of a tubular neck according to the invention.

### DETAILED DESCRIPTION OF THE PREFERRED EMBODIMENTS

Throughout the figures, the same reference signs relate to the same elements.

In this detailed description, the following embodiments are examples. Although the description refers to one or more embodiments, this does not mean that the features apply only to a single embodiment. Individual features of different embodiments can also be combined and/or interchanged in order to provide other embodiments.

The illustrated tank 1 for storing cryogenic fluid comprises a sealed inner shell 2, for example of generally cylindrical shape, defining the storage volume for the cryogenic fluid. The tank 1 further comprises a sealed outer shell 3 arranged around the inner shell 2 with a thermally insulated spacing. For example, the space between the outer shell 3 and the inner shell 2 is vacuum-sealed and contains a multilayer insulation (“MLI”).

The inner shell 2 and/or the outer shell 3 may be made of at least one of the following materials: carbon steel, stainless steel, aluminium and titanium.

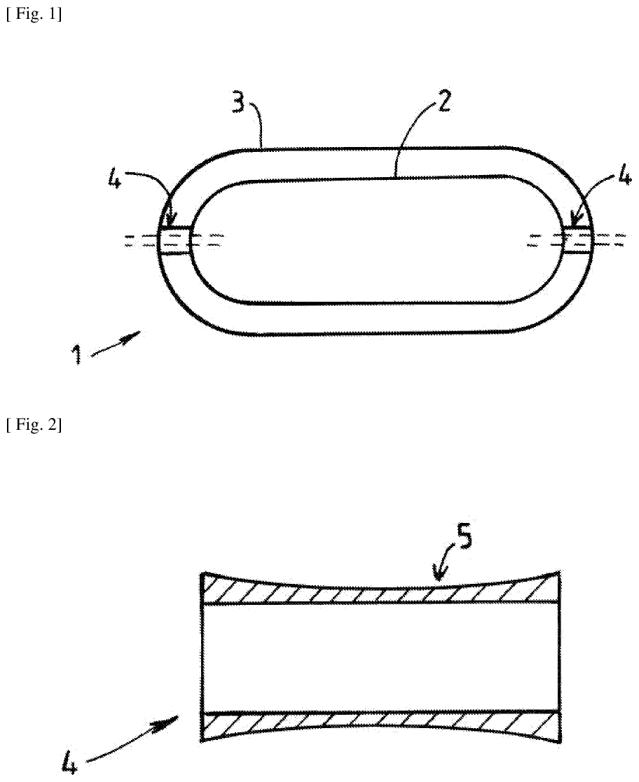

The inner shell 2 is mounted (or supported) in the outer shell 3 via at least one tubular neck 4 (two necks 4 in this example). The necks 4 extend in a longitudinal direction (which is horizontal in the configuration of FIG. 1).

The neck 4 may be made of at least one of the following materials: carbon steel, stainless steel, aluminium, titanium and composite material.

According to one advantageous specific feature, at least one of the necks 4 comprises, in the longitudinal direction, a portion 5 of somewhat thinned or reduced thickness.

The inventors have in fact observed that the thickness of the neck or necks 4 can be reduced locally, in particular in zones that are subject to less mechanical stress, without adversely affecting the mechanical strength of the tank and the thermal performance of the latter.

The relative reduction in thickness also reduces heat transfer by conduction.

The correlation between the variation in thickness and the thermal gain is difficult to describe, because the thickness of a neck is a size dependent on various parameters, such as its diameter, which itself is dependent on the diameter of the tank, on the weight of the tank or else on the loads to which it is subjected. However, a thermal gain of 30 to 40% can in particular be achieved via this localized reduction in neck thickness.

This thermal gain of up to 30 to 40% can be achieved in particular for a tank with a diameter of less than 1 m, making it possible to have a neck with a diameter of less than 200 mm, for an internal tank mass of less than 500 kg subjected to relatively low loads (corresponding, for example, to static use of the tank: for example, at most a force of 4 g in the three directions x, y, z).

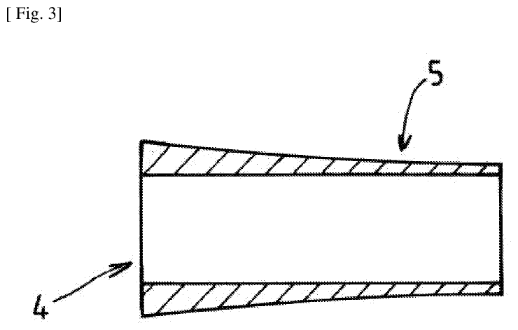

As shown in FIG. 1 and FIG. 2, the inside diameter of the neck 4 may be constant over its length, the portion 5 of somewhat thinned thickness in the longitudinal direction being formed by a variation in the outside diameter of the neck 4. This makes it possible to maintain cylindrical guidance in the inner part and facilitates machining of the neck.

Preferably, the localized reduction in thickness is formed by a progressive (continuous) reduction in the thickness of the neck 4 in the longitudinal direction.

For example, the progressive reduction in the thickness of the neck 4 in the longitudinal direction may be between 0.5 and 2 mm of thinning for a progression of 100 mm in the longitudinal direction, for example 1 mm of thickness less every 100 mm. This limits stress concentrations at changes in thickness.

The neck or necks 4 have, for example, a thickness of between 0.5 and 5 mm and preferably of between 1 and 3 mm, the thinned portion 5 having, for example, a thickness reduced by 5% to 70% relative to the non-thinned thickness.

For example, the thickness of the neck 4 in the non-thinned part may be 3 mm, while the smallest thinned thickness may be of the order of 1 mm.

The neck 4 (when the tank has only one neck) or at least one of the two necks (when the tank has two necks, as shown) may be of the fixed type, i.e. the two longitudinal ends of the neck are rigidly connected to fixed points situated respectively on the inner shell 2 and on the outer shell 3. In this case, the portion 5 of somewhat thinned thickness is preferably situated between the two longitudinal ends of the neck 4, for example in the middle part of the neck 4 cf. FIG. 2.

Indeed, for a fixed neck 4, the tube is constrained in displacement and in rotation at its two longitudinal ends. The stress distribution is therefore symmetrical over the length. If only half of the tube (in the length) is considered, it can readily be likened to a bending beam. The stress concentration is therefore greater close to the ends. A greater thickness is therefore necessary at the ends of the neck with a reduction in thickness symmetrically over the length of the neck.

The neck or one of the necks may be of the mobile type, that is to say may have a first longitudinal end rigidly connected to a fixed point, for example the outer shell 3, and a second longitudinal end connected to a point having freedom of movement, for example the inner shell 2, in order to allow relative movement so as to absorb thermal expansions, for example. In this case, the portion 5 of somewhat thinned thickness is preferably situated at the (mobile) second longitudinal end cf. FIG. 3.

Indeed, a mobile neck 4 is constrained in displacement and in rotation at a single longitudinal end. It can therefore also be likened to a bending beam, but over its entire length. The zone where the stress is the least significant is therefore its free end, which will therefore be the zone with the smallest thickness. The reduction in thickness is preferably provided continuously over the length.

The inventors have determined that the mechanical stresses are distributed in a non-uniform manner over the length of the neck 4, the parts in the vicinity of the mechanically “locked” zones being subjected to a greater stress than the parts which are distant therefrom.

The neck or necks 4 may be manufactured using several known manufacturing methods depending on the dimensions of the neck, in particular its diameter, its length and the reduction in thickness to be achieved: for example by machining, spin forming or hydroforming.

Although the embodiment illustrated relates to a tank 1 arranged horizontally in the configuration of use (horizontal longitudinal axis), the invention can also be applied to vertical tanks (neck arranged vertically at the upper end, for example).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-5. (canceled)

6. A tank for storing cryogenic fluid, comprising:
a sealed inner shell defining the storage volume for the cryogenic fluid and a sealed outer shell arranged around the inner shell with a thermally insulated spacing,
the inner shell being connected to the outer shell via at least one tubular neck extending in a longitudinal direction,
the neck comprising, in the longitudinal direction, a portion of thinned thickness, the portion of thinned thickness being formed by a progressive and continuous reduction in the thickness of the neck in the longitudinal direction,
wherein the inside diameter of the neck is constant,
the portion of thinned thickness in the longitudinal direction being formed by a variation in the outside diameter of the neck and in that the neck has a thickness of between 0.5 and 5 mm, the thinned portion having a thickness reduced by 5% to 70% compared with the non-thinned thickness and in that the neck is of the fixed type,
the two longitudinal ends of the neck being rigidly connected to fixed points situated on the inner shell and on the outer shell respectively,
the portion of thinned thickness being situated between the two longitudinal ends of the neck, or in that the neck is of the mobile type and has a first longitudinal end rigidly connected to a fixed point,
the portion of thinned thickness being situated at the second longitudinal end.

7. The tank according to claim 6, wherein the progressive reduction in the thickness of the neck in the longitudinal direction is between 0.5 and 2 mm of thinning for a progression of 100 mm in the longitudinal direction.

8. The tank according to claim 6, further comprising two necks situated at two respective ends of the tank.

9. The tank according to claim 6, wherein the inner shell and/or the outer shell is made of at least one of the following: carbon steel, stainless steel, aluminium and titanium.

10. The tank according to claim 6, wherein the neck is made of at least one of the following: carbon steel, stainless steel, aluminium and titanium.
